(19) United States
(12) Patent Application Publication
(10) Pub. No.: US 2009/0118561 A1
(43) Pub. Date: May 7, 2009

(54) Method for Gasification of Carbonic Materials Using CO2 and Apparatus for Performing Same

(75) Inventor: Rodrigo B. Vera, Leeds, AL (US)

Correspondence Address: LANIER FORD SHAVER & PAYNE P.C., P O BOX 2087, HUNTSVILLE, AL, 35804-2087, US

(73) Assignee: PLASMA WASTE RECYCLING, INC., Huntsville, AL (US)

(21) Appl. No.: 11/934,510

(22) Filed: Nov. 2, 2007

(51) Int. Cl. A62D 3/19; B09B 3/00

(52) U.S. Cl. 588/311; 422/184.1; 588/405

(57) ABSTRACT

A method for gasification of carbonic materials using CO₂ is disclosed where materials having at least some carbon content are subjected to a high-temperature environment, for example, inside a reactor vessel in which a plasma are a plasma torch or the like is energized. CO₂ is injected into such an environment in a substantially stoichiometric amount with respect to the amount of carbon within the carbonic components.

### FIELD OF THE INVENTION

This invention relates to apparatuses and methods for gasification of carbonic materials, and, specifically to an apparatus and method for gasification that employs carbon dioxide.

### BACKGROUND

For centuries, solutions have been sought as to what to do with solid waste that communities and industries tend to generate. Waste has been buried, sunk, and where possible recycled, or converted to other uses, to remove such waste from human habitation. For decades, efforts have been made to convert waste to other useful materials by the application of a high-temperature plasma arc or torch, a.k.a. partial oxidation. Where such waste included organic materials, it has been found advantageous to gasify such materials, or convert them to gas. Typically, the resulting products of gasification of organic and inorganic materials include inorganic slag, metals, and, from the organic component, product synthesis gas, or “syngas.”

The resulting materials obtained from the conversion process have many uses in other areas and so can be of value. Syngas, for example, which comprises at least carbon, carbon monoxide, and hydrogen, may be burned directly in internal combustion engines, used to produce methanol, which in turn has a vast array of applications, or may be converted into a synthetic fuel. However, the reaction should ideally be controlled in order to predict the resulting syngas composition. Variables that require the greatest control in the process include the amount and composition of carbonic feed material, i.e., material having at least some carbon content, including, without limitation, coal, petroleum-based products, tires, biomass, municipal solid waste (MSW) containing carbon, and other organic material, the speed at which the feed material is fed into the furnace, the density of the material, and the amount of ambient air trapped within the material.

High temperature reactors, such as plasma reactors used for conversion of organic and inorganic feed material, have been used for gasification of feed materials. Such organic and inorganic feed materials are inserted into a reactor chamber and are therein subjected to high energy generated by a plasma arc, or a plasma plume. The energy levels are typically greater than the Gibbs' “Enthalpy of Formation” values for feed material, and, consequently, the exposed material is dissociated. The resulting product in the reactor chamber is syngas, which is accurately conceived of as a plurality of gases that can include carbon monoxide (CO), hydrogen, nitrogen, hydrogen chloride, acetylene, methane, polycyclic and other gases, depending upon the solid material being reacted, the feed rate of the reactant and the amount of energy input to the reactor chamber, which rises to the top portion of the reactor chamber. Below that gas region is a layer of frothy “slag” in which resides oxidized metals from the dissociation process, such as silica (SiO₂), Magnesium Oxide (MgO) and Aluminum Oxide (Al₂O₃). Forming a layer on the bottom of the chamber is a bed of molten iron, or a molten iron alloy. In known processes of this type, oxygen is typically injected into the reactor in a steam medium or as pure oxygen gas to increase the efficiency of the reactor by combining with the emerging carbon and to aid in the formation of CO, as well as enabling oxidation of the inorganic materials.

CO₂ is known as a greenhouse gas and is believed by many to be a contributing factor in the phenomenon known as global warming. Consequently, there have been efforts to reduce the amount of CO₂ released to the atmosphere. Theses efforts typically involve reduction of the emission of CO₂ gas through the use of alternative energy sources. There are also efforts to reduce atmospheric CO₂ gas through enhancing natural CO₂ sinks, such as forests, oceans and soils, and developing methods to artificially sequester CO₂ gas.

Artificial sequestration of CO₂ involves capturing CO₂ and then depositing it in an environment in which it will not enter the atmosphere. For example, CO₂ is scrubbed from gas resulting from burning of fossil fuels, typically in large scale, power plants, through separation or absorption. CO₂ is then injected into a storage location.

One proposed form of sequestration is direct injection of CO₂ into the ocean at a depth wherein the CO₂ forms solid clathrate hydrates which ultimately dissolve into the surrounding waters. Geological sequestration of CO₂ has been used for some decades, through pumping CO₂ into declining oil wells to bring more oil to the surface, into unminable coal fields wherein the gas is absorbed into the coal, and into saline aquifers. CO₂ is even pumped into caves and abandoned mines.

These methods require a great deal of energy to generate and maintain the required pressure to deliver the gas, which may negate the beneficial effects of sequestration. Also, there are several safety issues that arise from these methods. Moreover, there is some question whether some methods of sequestration considered at this time might cause detrimental environmental effect. Some methods do not yield a useful by-product and, accordingly, the cost of sequestration might outweigh the benefit.

A method of gasification has been developed which efficiently disposes of CO₂ in combination with high-temperature processing of carbonic materials, which may include waste materials. This method results in a substantially complete fixing of carbon into other forms which prevents its release into the atmosphere in the form of CO₂.

### SUMMARY

The present disclosure is directed to a method of gasification of materials having a carbonic component which uses carbon dioxide to assist in reduction, and to enhance formation of carbon monoxide.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

Materials having at least some carbonic component are subjected to a high-temperature environment, for example, inside a reactor vessel in which a plasma arc, a plasma torch or the like is energized. CO₂ is injected into such an environment in a substantially controlled stoichiometric amount with respect to the amount of carbon within the carbonic components within the materials.

In a further embodiment, carbon monoxide is extracted from the reactor environment.

In still a further embodiment, the amount of carbon dioxide injected into the reactor vessel is controlled through the detection and measuring of post-reaction amounts of either of carbon dioxide, or carbon particulate matter or both.

An apparatus which employs such a method includes a reactor vessel that has an opening for the introduction of materials having some carbon content; high-temperature generating means for creating a high-temperature environment within the reactor vessel; a supply of carbon dioxide in communication with the reactor interior via a conduit; a detector for determining the amount of carbon particulate matter within the vessel configured to issue a signal in the event carbon particulate matter is at least a pre-determined amount; a control system for receiving the signal and issuing commanding the operation of a regulator operable to vary the amount of carbon dioxide injected into the reactor vessel such that carbon dioxide is provided into said reactor in a substantially stoichiometric amount with respect to carbon content.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is an exemplary reactor for a plasma gasification system embodying the principles of the present invention;

FIG. 2 is an alternative embodiment of the exemplary reactor;

FIG. 3 is further alternative embodiment of the exemplary reactor;

FIG. 4A is a partial top plan section view of a reactor vessel in a further embodiment;

FIG. 4B is a partial top plan section view of a reactor vessel in a further embodiment

FIG. 4C is a partial top plan section view of a reactor vessel in a further embodiment; and

FIG. 5 is a functional diagram of another embodiment of the present invention.

### DETAILED DESCRIPTION

The various embodiments of the present invention and their advantages are best understood by referring to the Figures. The elements of the drawings are not necessarily to scale, emphasis instead being placed upon clearly illustrating the principles of the invention. Throughout the drawings, like numerals are used for like and corresponding parts of the various drawings.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment. Moreover, features described with respect to a particular embodiment may also be employed in other disclosed embodiments as those skilled in the relevant arts will appreciate. This invention may be provided in other specific forms and embodiments without departing from the essential characteristics as described herein. The embodiments described below are to be considered in all aspects as illustrative only and not restrictive in any manner.

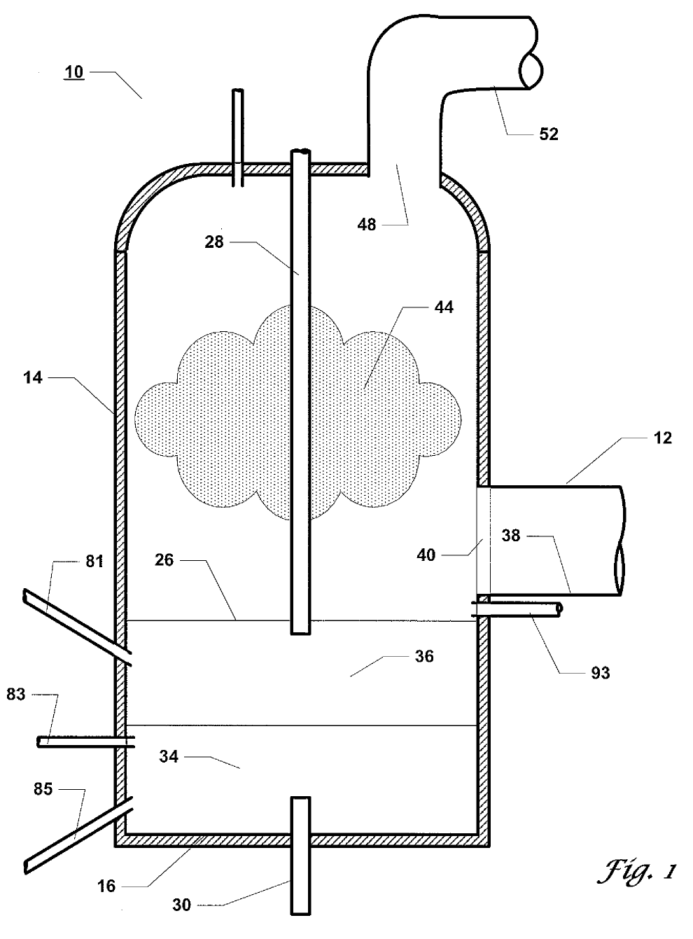

Referring now in detail to the drawings, there is illustrated in FIG. 1, a pictorial diagram of an apparatus 10 for gasification of carbonic materials. The apparatus 10 includes a feeder system 12, and a refractory-lined reactor vessel 14. The feeder system 12 is provided for feeding materials consisting of organic and, possibly, inorganic components into the refractory-lined reactor vessel 14 at a controlled rate. The feeder system feeds a stream of shredded and/or compacted materials into the reactor vessel in a controlled, continuous manner. The materials may include, but are not limited waste materials, such as municipal solid waste (MSW), medical type waste, radioactive contaminated waste, agricultural waste, pharmaceutical waste, and the like. Other possible materials for processing include, without limitation, coal, tires, plastics and biomass. In essence, carbonic materials could be anything that includes an organic or carbon component.

The materials are delivered into the reactor vessel at a controlled rate so as to expose a predetermined amount of compacted material to the thermal decomposition process for regulating the formation of product synthesis gases (syngas). The feed rate is dependent upon the characteristics of the fed materials as well as the temperature and oxygen conditions within the reactor vessel. Inside of the reactor vessel 14, a high temperature plasma arc generates temperatures in excess of 2,900° F. so that, upon entry of the material stream, it is immediately dissociated with the organic portion of the material being converted to carbon and hydrogen and the inorganic portion and metals of the material melted with the metal oxides being reduced to metal. A DC graphite cathode electrode 28 extending through the roof of the reactor and an anode electrode 30 formed in the bottom of the reactor vessel are connected to a DC power supply (not shown) so as to create the high temperature plasma arc, as will be more fully described below. Alternatively, when two separate DC power supplies are used, each one is connected to one of the top electrodes and the bottom cathode electrode. It will be appreciated by those skilled in the relevant arts with the benefit of reading this disclosure that the concepts described herein may be applied advantageously in other high-temperature reactor systems that use heat sources such as, AC electrodes, DC plasma torches in transferred or non-transferred mode, AC plasma torches, and that use other heating methods, for example, electrical induction, as long as the temperature within the reaction reaches a minimum of about 2900° F.

The bottom 16 of the reactor vessel 14 defines a hearth for receiving a molten metal bed or bath 26 which is heated by the plasma generated between the DC graphite electrode 28 (cathode) and the anode electrode 30. The cathode electrode 28 is mounted through the roof of the reactor and extends downwardly with its lower end being submerged in the molten bath 26. The anode electrode 30 is mounted through the center of the bottom 16 of the reactor vessel, facing opposite to the cathode electrode 28. Alternatively, it should be understood by those skilled in the art that the anode electrode 30 may be achieved with a conductive plate that defines the bottom 16 of the reactor vessel, or multiple cathodes may be spaced uniformly throughout the bottom 16 of the reactor vessel in lieu of using the rod electrode as illustrated. It will also be acknowledged that the upper electrode may be the anode and the lower electrode may be the cathode.

During operation, the molten bath 26 filling the bottom 16 of the reactor vessel 14 will be separated into a bottom metal (iron) layer 34 and an inorganic “foamy” or “gassy” slag layer 36. This is due to the density differences between the materials and the fact that slag is not soluble in the metal. It will be noted that the lower end of the cathode electrode 28 is preferably submerged into the slag layer 36. The feed materials are fed into the vessel 14 via a feeder extrusion tube 38 and opening 40. By injecting the feed materials as closely as possible to the slag layer 36 of the molten bath 26, the feed materials are substantially immediately subjected to very high temperatures, i.e., above about 2900° F., that results in complete disassociation of the feed materials. Moreover, extrusion tube 38 and opening 40 are located just above the slag layer 36 in order to reduce entrainment of gas within the feed material as it falls into the molten bath 26.

The organic portion of the feed material will disassociate and reform into the synthetic gas (or “syngas”) 44 consisting of a carbon and hydrogen mixture and rising to the upper portion of the reactor vessel 14. The inorganic portion of the feed material will be melted with the metal oxides reducing to a metal, which is accumulated at the bottom of the molten bath 26 in a metal layer 34. Inorganic non-metallic compounds will form the vitreous slag layer 36 disposed above the metal layer 34.

A gas vent or duct 48 is also provided in the upper end of the reactor vessel 14, which is designed to convey the produced syngas 44 at a temperature of about 875 to 1,000° C. via a gas pipe 52 for further processing. The gas pipe 52 has a diameter to control the gas exiting velocity in order to minimize particulate entrapment and to maximize the efficiency of the plasma gasification.

The process of the present invention for converting the mixture of organic and inorganic portions of the materials into the vitreous slag and the syngas will now be explained. Initially, it should be understood that the present process has particular applications for the destruction of a wide variety of feed materials as well as for use in such industrial processes as coal gasification or the gasification of other feed materials. As the feed materials are delivered into the processing chamber 14 of the reactor vessel 14 by the feeder system 12, the feed materials will absorb energy by convection, conduction, and radiation from several sources including the long plasma arc discharges generated, the hot vitreous slag, the heated refractory lining, and the heated gases circulating within the processing chamber 14. As the organic portion of the feed materials is heated, it becomes increasingly unstable until it eventually disassociates into its elemental components consisting mainly of carbon and hydrogen.

The syngas 44 expands rapidly and flows from the processing chamber 14 to the gas pipe 52 via the gas vent or outlet 48. The process is designed to deliver the syngas 44 at a temperature of about 875 to 1,100 degrees C. for further processing. The gas pipe 52 is designed to be airtight so as to prevent the syngas 44 from escaping or allowing atmospheric air to enter. The gas pipe 52 is also preferably refractory lined in order to maintain the effective temperature of the syngas 44 above 875 degrees C. to substantially prevent the formation of complex organic components such as dioxins, furans, and acid gases and to recover as much of the latent gas enthalpy as possible. Gas pipe 52 includes exhaust fan (not shown) for creating a low pressure area downstream from the vent 48 to assist in drawing syngas 44 from the reaction chamber 14.

The reactor includes a plurality of tap ports for extracting the slag layer 36 and metal layer 34 components from the chamber. A slag tap port conduit 81 is located to be in communication with the slag layer 36 and is formed at a declining angle so that the opening on the interior of the vessel wall is lower than the remainder of the conduit 81. This prevents outside air from reaching the slag layer and contaminating the contents of the vessel. A metal tap port conduit 83 is located to be in communication with the metal layer 34. Also, the reactor vessel is preferably configured with an emergency metal tap port conduit 85 with an opening also in communication with the metal layer 34. This conduit is angled so that the opening is higher than the remainder of the conduit which slopes away from the reactor. This port is used is the event of a reactor emergency and the metal layer is required to be extracted quickly.

The inventive reactor apparatus also includes a conduit 93 for the introduction of CO₂. CO₂ conduit 93 is in communication with a CO₂ supply system that is configured to supply CO₂ at a pressure sufficient to eject it to the center of the reactor vessel 14. The amount of CO₂ supplied should be stoichiometrically maintained in relation to the amount of carbon that will be available from the reacted feed material in order to obtain CO in accordance with the Boudouard reaction.

The Boudouard reaction is a reversible reduction reaction shown as:

CO₂+C [symbol] 2CO

which tends toward equilibrium. In lower temperature environments, the equilibrium tends toward the exothermic CO₂ side. Conversely, it will be appreciated that the high-temperature environment of the reactor is ideal for endothermic formation of CO. Thus, as organic materials are fed into the reactor vessel, they are dissociated and carbon is released. CO₂ introduced via the CO₂ conduit 93 gasifies the free carbon resulting in CO which may be extracted for farther processing, fixing the CO into an organic polymer such as methanol or sold for use in making other materials.

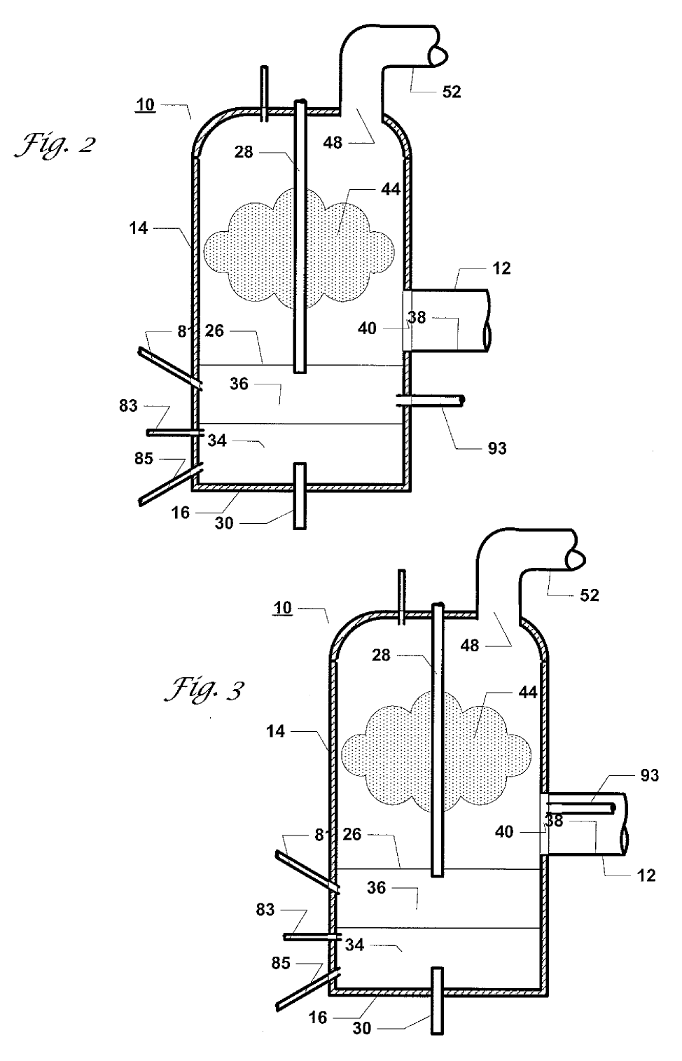

It should be noted that the CO₂ conduit could be located anywhere in the wall of the reactor vessel 14. It will be recognized, however, that certain locations may be better in terms of promoting greater efficiency of reaction than other locations. FIG. 2 depicts an alternative location of the CO₂ conduit 93 where it opens directly into the slag layer 36. As the CO₂ is injected into the slag layer 36 it dissociates into CO and oxygen. Any remaining unreacted oxygen bonds with silicon, aluminum and magnesium to form the metal oxides that comprise the slag layer. A further advantage is realized as the slag foam tends to trap carbon particulates releasing more gaseous carbon. FIG. 3 illustrates another embodiment in which the CO₂ conduit 93 is located above the feed tube 38.

As would be suggested in FIGS. 1, 2 and 3 to those of skill in the art: it is preferable to locate the CO₂ conduit 93, in terms of height with respect to the reactor, as close to the feed tube opening 40 as possible. When placing the CO₂ conduit 93 above the feed opening 40, it should appear no more that half the height of the tube above the top of the tube opening 40. This is because most of the carbon will be in that lower portion of the reactor 14 (meaning the volume from the slag layer to slightly above the feed opening 40) at the outset after the feed material is fed into the reactor 14

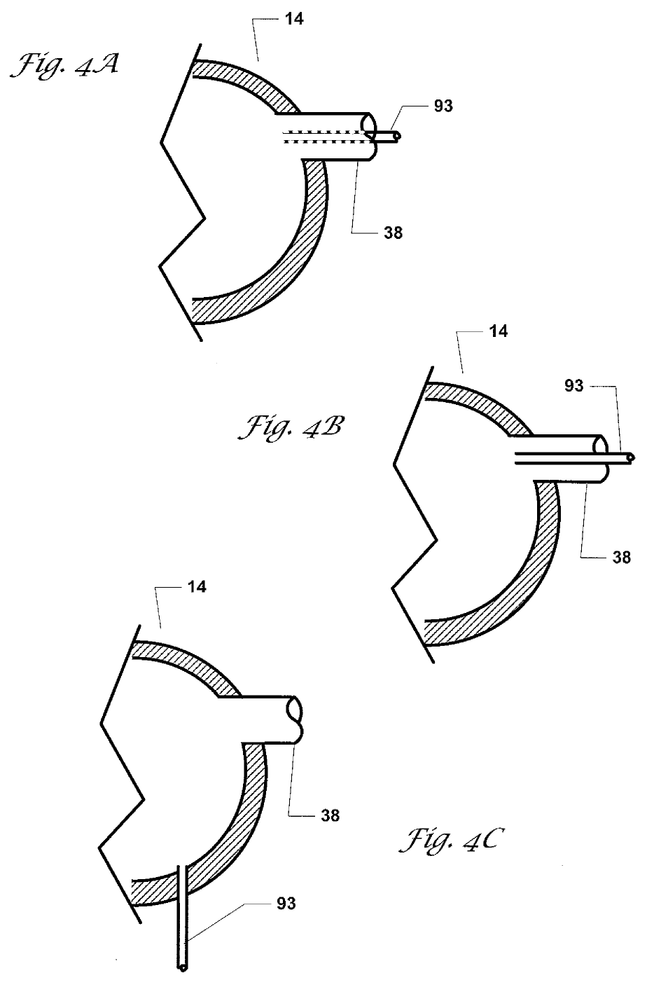

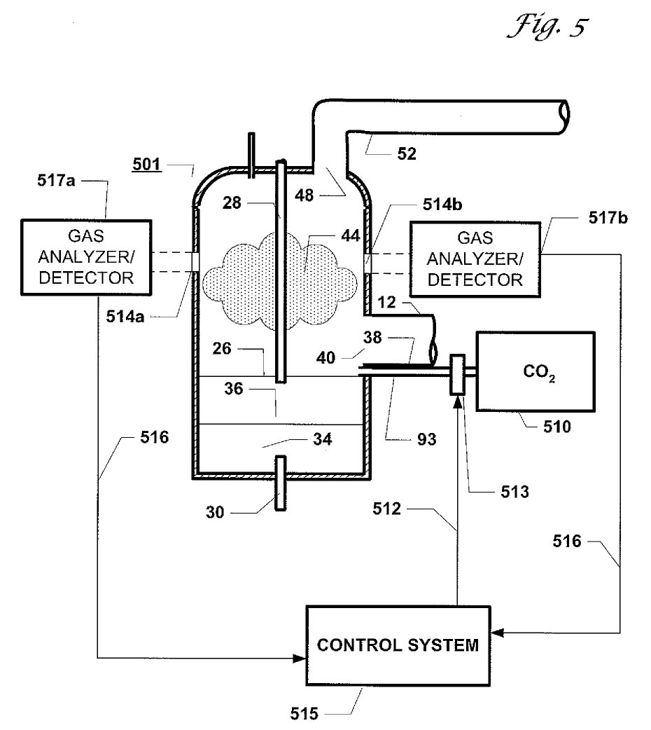

FIGS. 4A through 4C depict other possible locations for the CO₂ conduit 93 in relation to the diameter of the reactor vessel 14. In FIGS. 4A through 4C feed tube 38 enters the reactor vessel 14 off-set with respect to the center of the vessel. In FIGS. 4A and 4B, CO₂ conduit is located in the same area with respect to the center of the reactor vessel 14, whether disposed above the feed tube 38 (FIG. 4B) or below the feed tube 38 (FIG. 4A). FIG. 4C shows a further version in which the CO₂ conduit 93 is located in a quadrant of the reactor vessel 14 wall different from that of the feed tube 38. The conduit 93, although not required, is also offset with respect to the center of the reactor vessel 14. This is to impel continued circulation of the gas or slag layer.

FIG. 5 is a functional diagram of an exemplary system for plasma gasification 501 for providing CO₂ to the reactor vessel in substantially stoichiometric amounts with respect to the amount of carbon generated in the reactor vessel 14. Reactor vessel 14 is configured with a feeder system 12 comprising a feed tube 38 in communication with an opening 40 defined in the refractory wall of the reactor vessel 14. The reactor vessel 14 is equipped with a plasma cathode 28 and anode 30 for generating a high-temperature, i.e., greater than about 2,900° F., environment. Feed material containing some carbon content enters the reactor vessel 14 through the opening 40 and is subjected to the energy generated by the plasma arc, and, as a result, dissociates into constituent components as described above

As the feed material dissociates, syngas 44 forms and rises to the upper portion of the reactor vessel 14. Carbon released from the feed material comprises a portion of the syngas. CO₂ is injected into the reactor vessel 14 through conduit 93 in communication with a CO₂ supply 510. Intermediate the reactor vessel 14 and the CO₂ supply 510, along the conduit 93, is a regulator 513. Regulator 513 is an electro-mechanical device that is configured to be responsive to command signals 512 from control system 515 and is operable to render variable control to the amount of CO₂ flowing through the conduit 93 and into the reactor vessel 14.

The reactor vessel 14 includes one or more windows 514a,b through which one or more gas analyzer/detector 517a,b analyzes the environment within the reactor vessel 14, and particularly, analyzes the content of the syngas 44. Analyzer/detector 517 is configured to detect the presence of unreacted carbon, which will be present in the form of particulate matter within the syngas and emit a signal 516 to the control system 515 in the event the amount of carbon particulate is greater than a pre-determined amount. Too much carbon particulate matter indicates that not all of the carbon from the material is being reacted with oxygen and so more CO₂ is needed. In this event, control system 515 issues a command signal 512 to the regulator 513 to allow more CO₂ from the CO₂ supply 510 to enter the reactor vessel 14

Analyzer/detector 517a,b may also be configured to detect the presence of CO₂ within the reactor vessel 14 through spectrum analysis. The amount of CO₂ is also measured. In the event CO₂ is present in an amount greater than a pre-determined amount, Analyzer/detector 517a,b is also configured to emit a signal 516 to the control system 515. The presence of too much CO₂ indicates that more CO₂ is being injected into the reactor vessel 14, which means that there is more oxygen than there is carbon being released from the dissociation of the feed material. Consequently, the control system 515 after receiving the detection signal 516 issues a command signal 512 to the regulator 513 to close, at least partially, to reduce the amount of CO₂ being injected into the reactor vessel.

Control system 515 and, analyzer/detector 517 may each be implemented using computer-based components, or processors. Such a processor can be implemented by a field programmable gated array (FPGA), a central processing unit (CPU) with a memory or other logic device. A processor in effect comprises a computer system. Such a computer system includes, for example, one or more processors that are connected to a communication bus. The computer system can also include a main memory, preferably a random access memory (RAM), and can also include a secondary memory. The secondary memory can include, for example, a hard disk drive and/or a removable storage drive. The removable storage drive reads from and/or writes to a removable storage unit in a well-known manner. The removable storage unit, represents a floppy disk, magnetic tape, optical disk, and the like, which is read by and written to by the removable storage drive. The removable storage unit includes a computer usable storage medium having stored therein computer software and/or data.

The secondary memory can include other similar means for allowing computer programs or other instructions to be loaded into the computer system. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to the computer system.

Computer programs (also called computer control logic) are stored in the main memory and/or secondary memory. Computer programs can also be received via the communications interface. Such computer programs, when executed, enable the computer system to perform certain features of the present invention as discussed herein. In particular, the computer programs, when executed, enable a control processor to perform and/or cause the performance of features of the present invention. Accordingly, such computer programs represent controllers of the computer system.

In an embodiment where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein.

In another embodiment, features of the invention are implemented primarily in hardware using, for example, hardware components such as application specific integrated circuits (ASICs) or field-programmable gated arrays (FPGAs). Implementation of the hardware state machine so as to perform the functions described herein will be apparent to persons skilled in the relevant art(s). In yet another embodiment, features of the invention can be implemented using a combination of both hardware and software

As described above and shown in the associated drawings, the present invention comprises a reactor vessel for plasma gasification reactors. While particular embodiments of the invention have been described, it will be understood, however, that the invention is not limited thereto, since modifications may be made by those skilled in the art, particularly in light of the foregoing teachings. It is, therefore, contemplated that any claims issuing in an ensuing patent will cover any and all such modifications that incorporate those features or those improvements that embody the spirit and scope of the present invention.

I claim:

1. A method for high-temperature gasification of carbonic material comprising the steps of;
applying heat energy to carbonic material in a high temperature environment; and
injecting carbon dioxide into said environment in a substantially stoichiometric amount with respect to the amount of carbon releasable from said carbonic material.

2. The method for high-temperature gasification of claim 1, further comprising the step of:
extracting at least carbon monoxide from said environment.

3. A method for disposing of carbon dioxide comprising the steps of:
controllably introducing carbon dioxide into a high-temperature reactor in the presence of plasma energy applied to organic solid waste materials.

4. The method of claim 3, further comprising the step of extracting carbon monoxide from said reactor.

5. A method for plasma gasification comprising the steps of:
controllably feeding materials into a high-temperature plasma reactor, wherein said materials comprise an amount of carbon;
applying a plasma energy to said solid waste materials in the presence of carbon dioxide, said carbon dioxide being in a substantially stoichiometric amount with respect to said amount of said carbon; and
extracting carbon monoxide gas from said reactor.

6. The method of claim 5, further comprising the step of:
evaluating the amount of carbon within said reactor and controllably injecting carbon dioxide into said reactor substantially stoichiometrically based upon said amount of carbon.

7. The method of claim 5, farther comprising the step of:
evaluating the amount of carbon dioxide within said reactor and controllably reducing carbon dioxide presence within said reactor.

8. The method of claim 7, further comprising the step of:
evaluating the amount of carbon within said reactor and controllably injecting carbon dioxide into said reactor substantially stoichiometrically based upon said amount of carbon.

9. An apparatus for plasma gasification of carbonic materials comprising:
a reactor vessel having an opening for the introduction of materials having some carbon content into said vessel;
a plasma generating means within said reactor vessel operative for creating a high-temperature environment within said reactor vessel suitable for dissociation of said materials therein;
a supply of carbon dioxide in communication with the interior of said reactor vessel via a conduit such that carbon dioxide may be injected into said reactor vessel;
a detector for determining the amount of carbon particulate matter within said reactor configured to issue a first output signal in the event the amount of said carbon particulate matter is at least a predetermined amount;
a computer-based control system for receiving said first signal and issuing a second output signal; and
a regulator responsive to said second output signal, said regulator being coupled to said supply intermediate said reactor vessel and operable to vary the amount of carbon dioxide injected into said reactor vessel such that said carbon dioxide is provided into said reactor in a substantially stoichiometric amount with respect to said carbon content.

10. The apparatus of claim 9, further comprising a detector for determining the amount of carbon dioxide present within said reactor configured to issue a third signal in the event the amount of said carbon dioxide is at least a pre-determined amount, and wherein said control system receives said third signal.

11. The apparatus of claim 10, wherein said plasma generating means is one of a DC electrode, an AC electrode, and a plasma torch.

12. A method for plasma gasification using CO₂ as an oxidizing agent comprising the steps of:
controllably feeding materials into a high-temperature plasma reactor, wherein said materials comprise an amount of carbon;
applying a plasma energy to said solid waste materials in the presence of carbon dioxide injected into said plasma reactor, said carbon dioxide being in a substantially stoichiometric amount with respect to said amount of said carbon releasable from dissociation of said materials, and
extracting carbon monoxide gas from said reactor.

13. The method of claim 12, further comprising the step of:
evaluating the amount of carbon matter within gas within said reactor and controllably injecting carbon dioxide into said reactor substantially stoichiometrically based upon said amount of carbon matter.

14. The method of claim 12, further comprising the step of:
evaluating the amount of carbon dioxide within said reactor and controllably reducing carbon dioxide amounts injected into said reactor.

15. An apparatus for plasma gasification of carbonic materials comprising:
a reactor vessel having an opening for the introduction of materials having some carbon content into said vessel;
a plasma generating means within said reactor vessel operative for creating a high-temperature environment within said reactor vessel suitable for dissociation of said materials therein;
a supply of carbon dioxide in communication with the interior of said reactor vessel via a conduit such that carbon dioxide may be injected into said reactor vessel;
a detector for determining the amount of carbon matter within said reactor configured to issue a first output signal in the event the amount of said carbon matter is at least a predetermined amount;
a computer-based control system for receiving said first signal and issuing a second output signal; and
a regulator responsive to said second output signal, said regulator being coupled to said supply intermediate said reactor vessel and operable to vary the amount of carbon dioxide injected into said reactor vessel such that said carbon dioxide is provided into said reactor in a substantially stoichiometric amount with respect to said carbon released through dissociation of said materials.

16. The apparatus of claim 15, further comprising a detector for determining the amount of carbon dioxide present within gases within said reactor configured to issue a third signal in the event the amount of said carbon dioxide is at least a pre-determined amount, and wherein said control system receives said third signal.

17. The apparatus of claim 15, wherein said plasma generating means is one of a DC electrode, an AC electrode, and a plasma torch.

18. The apparatus of claim 17, further comprising a detector for determining the amount of carbon dioxide present within gases within said reactor configured to issue a third signal in the event the amount of said carbon dioxide is at least a pre-determined amount, and wherein said control system receives said third signal.
